(19) United States
(12) Patent Application Publication
(10) Pub. No.: US 2007/0103300 A1
(43) Pub. Date: May 10, 2007

(54) BURGLAR ALARM SYSTEM AND METHOD FOR A PORTABLE DEVICE

(75) Inventor: Chao-Dong Peng, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,595

(22) Filed: Aug. 28, 2006

(30) Foreign Application Priority Data
Nov. 9, 2005 (CN) 200510101228.0

(51) Int. Cl. G08B 13/14; G08B 21/00; G06F 12/14; G06F 11/00

(52) U.S. Cl. 340/571; 340/686.1; 726/17; 726/35

(57) ABSTRACT

A burglar alarm method for a portable device configured with a vibrating sensor. The vibrating sensor is structured and arranged for generating a first voltage upon sensing a vibration coming from the portable device, and sending a first signal if the first voltage exceeds a predefined voltage. The burglar alarm method includes the steps of: setting security parameters that comprise the predefined voltage and a verifying password; receiving the first signal sent form the vibrating sensor (14) if a hot key of the portable device is pressed; generating an alarm signal to an alarm unit (16) for sending an alarm and locking the hot key if the first signal has been received; providing a user interface for inputting a response password by a user; analyzing whether the response password is valid by comparing the response password with the verifying password; turning off the alarm unit and unlocking the locked hot key if the response password is valid; and sending the alarm via the alarm unit and locking the hot key if the response password is invalid. A related system is also disclosed.

### FIELD OF THE INVENTION

The present invention generally relates to systems and methods for securing portable devices, and more particularly to a burglar alarm system and method for a portable device.

### DESCRIPTION OF RELATED ART

With the importance of computer devices in businesses, academics and personal usages, more and more easy-to-carry computer devices, such as laptop computers and PDA (Personal Digital Assistant) devices, are widely used in business offices, schools, libraries or at home. However, such easy-to-carry computer devices are susceptibly stolen by thieves. More importantly, such easy-to-carry computer devices are usually used to store important/sensitive data therein. Therefore, it is crucial to not only prevent such easy-to-carry computer devices from being stolen, but also to protect the crucial data stored in such easy-to-carry computer devices from being accessed by the thief.

Presently, several types of anti-theft devices are currently in the market. For example, in wire-type anti-theft devices, a lock device connected with a long wire is directly connected to a security slot in an easy-to-carry computer device, and the other end of the wire is wrapped around a fixture like a table and a desk. Such types of anti-theft devices are just used to prevent an easy-to-carry computer device from being snatched away easily by thieves. However, such easy-to-carry computer devices are easy to be stolen when the thieves destroy such types of anti-theft devices by using a strong force, and the crucial data stored in such easy-to-carry computer devices are easy to be accessed by the thieves.

What is needed, therefore, is a burglar alarm system and method for a portable device, that can overcome the above-described problems by sending an alarm with sounds or lights to inform the user whenever the portable device is in a danger state of being stolen, so as to firstly and securely protect the portable computer from being stolen.

### SUMMARY OF THE INVENTION

A burglar alarm system for a portable device configured with a vibrating sensor in accordance with a preferred embodiment includes an alarm unit and a security module of the portable computer. The vibrating sensor is structured and arranged for generating a first voltage upon sensing a vibration coming from the portable device, and sending a first signal if the first voltage exceeds a predefined voltage. The alarm unit is structured and arranged for sending an alarm when receiving an alarm signal. The security module is structured and arranged for determining whether to generate and output the alarm signal to the alarm unit, and includes an input sub-module, an analyzing sub-module and a processing sub-module. The input sub-module is structured and arranged for setting security parameters that comprise the predefined voltage and a verifying password, receiving the first signal sent from the vibrating sensor, and providing a user interface for inputting a response password by a user. The analyzing sub-module is structured and arranged for analyzing whether the first signal has been received by way of communicating with the input sub-module, and analyzing whether the response password is valid by comparing the response password with the verifying password. The processing sub-module is structured and arranged for generating the alarm signal to the alarm unit for sending an alarm and locking a hot key of the portable device if the first signal has been received, and for turning off the alarm unit and unlocking the locked hot key if the response password is valid.

Another preferred embodiment provides a burglar alarm method for a portable device configured with a vibrating sensor in accordance with a preferred embodiment. The vibrating sensor is structured and arranged for generating a first voltage upon sensing a vibration coming from the portable device, and sending a first signal if the first voltage exceeds a predefined voltage. The burglar alarm method includes the steps of: (a) setting security parameters that comprise the predefined voltage and a verifying password; (b) receiving the first signal sent from the vibrating sensor if a hot key of the portable computer is pressed; (c) generating an alarm signal to an alarm unit for sending an alarm and locking the hot key if the first signal has been received; (d) providing a user interface for inputting a response password by a user; (e) analyzing whether the response password is valid by comparing the response password with the verifying password; (f) turning off the alarm unit and unlocking the locked hot key if the response password is valid; and (g) sending the alarm via the alarm unit and locking the hot key if the response password is invalid.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a burglar alarm system for a portable device configured with a vibrating sensor in accordance with a preferred embodiment;

FIG. 2 is a schematic diagram of main function modules of a security module of the system of FIG. 1;

FIG. 3 is a flowchart of a method for setting security parameters in accordance with a preferred embodiment; and

FIG. 4 is a flowchart of a burglar alarm method for a portable device configured with a vibrating sensor by using the security parameters of FIG. 3.

### DETAILED DESCRIPTION OF THE INVENTION

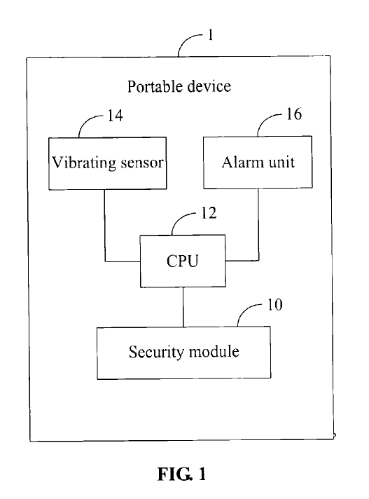

FIG. 1 is a schematic diagram of hardware configuration of a burglar alarm system for a portable device configured with a vibrating sensor in accordance with a preferred embodiment. A portable device 1 is configured with a vibrating sensor 14. The system includes a security module 10, and an alarm unit 16; the system is implemented in the portable device 1. The portable device 1 typically includes a central processing unit (CPU) 12 connected with the security module 10, the vibrating sensor 14, and the alarm unit 16 respectively.

The vibrating sensor 14 is structured and arranged for sensing the intensity of a vibration produced by the portable device 1, and sending a first signal to the security module 10 when the intensity of a vibration is beyond an allowable range. As a matter of fact, the vibrating sensor 14 is structured and arranged for transforming the intensity of the vibration into a first voltage. In other words, the vibrating sensor 14 is structured and arranged for sending the first signal to the security module 10 when the first voltage exceeds a predefined voltage.

The first signal is an alarm signal for informing the owner of the portable device 1 that the portable device 1 is in a danger state of being stolen, thus, activating the security module 10 to secure the portable device 1 correspondingly. In the preferred embodiment, the vibrating sensor 14 can also be another suitable type of sensor, such as a pressure sensor or a speed sensor. The alarm unit 16 is structured and arranged for sounding an alarm to alert that the portable device 1 is in a danger state of being stolen. In the preferred embodiment, the alarm unit 16 can also be a sound device for sounding an alarm with voice/sound, a light alarm device for signaling an alarm with lights, or any other suitable attention grabbing alarm device.

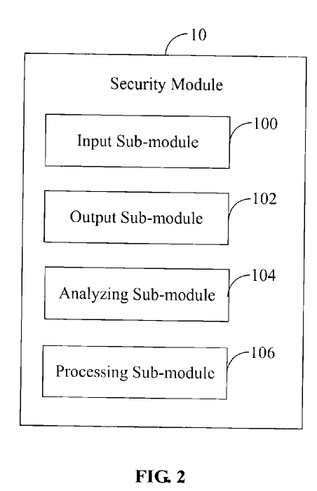

FIG. 2 is a schematic diagram of main function modules of the security module 10. The security module 10 includes an input sub-module 100, an output sub-module 102, an analyzing sub-module 104, and a processing sub-module 106.

The input sub-module 100 is structured and arranged for setting security parameters that include a verifying password, a predefined voltage (for example, 0.55 V) for the vibrating sensor 14, a hot key of the keyboard (not shown) for enabling/disabling the security module 10, and a state of the alarm unit 16. The state of the alarm unit 16 results in whether the alarm unit 16 is enabled or disabled. The verifying password is used in a password verification procedure for preventing an unauthorized user from using the portable device 1, and preventing crucial data from being accessed by a person with malicious intent.

The input sub-module 100 is further structured and arranged for receiving the first signal sent by the vibrating sensor 14, and for providing a user interface for inputting a response password by a user.

The output sub-module 102 is structured and arranged for displaying basic information of the owner of the portable device 1 by using a display (not shown) of the portable device 1. In the preferred embodiment, the basic information typically includes a name, an age, and an address of the owner of the portable device 1, and is stored in the portable device 1 by the owner himself/herself.

The analyzing sub-module 104 is structured and arranged for analyzing whether the first signal has been received by way of communicating with the input sub-module 100. Furthermore, the analyzing sub-module 104 is structured and arranged for analyzing whether to use the password verification procedure. Moreover, the analyzing sub-module 104 is structured and arranged for analyzing whether a response password inputted by the user is valid by comparing the response password with the verifying password set by the user.

The processing sub-module 106 is structured and arranged for generating an alarm signal to the alarm unit for sounding an alarm, and for locking the hot key and the mouse of the portable device 1, if the first signal has been received. The processing sub-module 106 is further structured and arranged for turning off the alarm unit 16 and unlocking the locked hot key and the locked mouse if the response password is valid.

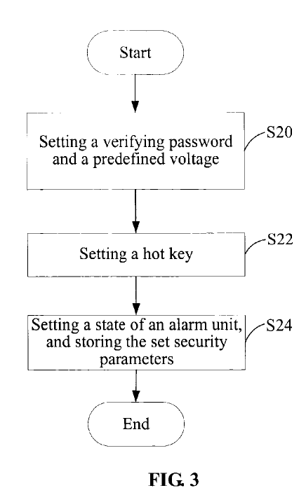

FIG. 3 is a flowchart of a method for setting security parameters in accordance with a preferred embodiment. In step S20, the input sub-module 100 sets a verifying password, and a predefined voltage (for example, 0.55V). In step S22, the input sub-module 100 sets a hot key (for example, a “Esc” key) of the keyboard for enabling/disabling the security module 10. The user may press the hot key to enable the security module 10 to secure the portable device 1 when the user is away from the portable device 1. In step S24, the input sub-module 100 sets a state of the alarm unit 16 resulting in whether the alarm unit 16 is enabled or disabled. The output sub-module 102 stores the security parameters set by the input sub-module 100.

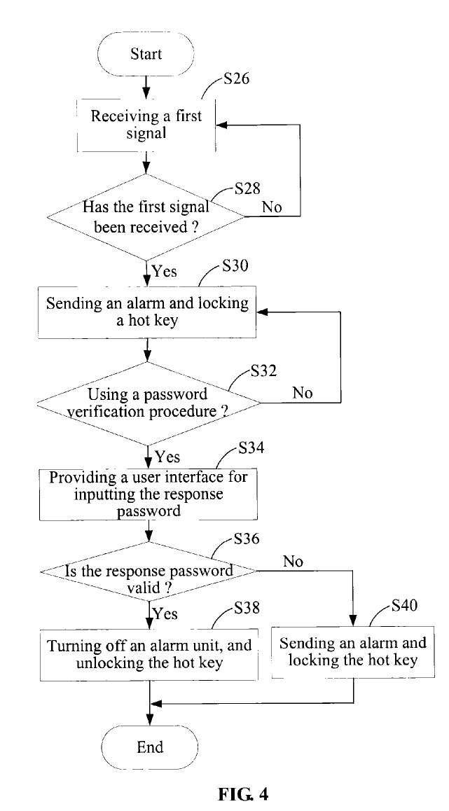

FIG. 4 is a flowchart of a burglar alarm method for a portable device configured with a vibrating sensor by implementing the system as described above. In step S26, the input sub-module 100 receives the first signal sent by the vibrating sensor 14 if the user has pressed the hot key. In step S28, the analyzing sub-module 104 analyzes whether the first signal has been received by way of communicating with the input sub-module 100. If the first signal has been received, in step S30, the processing sub-module 106 generates an alarm signal to the alarm unit for sounding an alarm, and locks the hot key. The alarm is used for alerting that the portable device 1 is in a danger state of being stolen. Otherwise, if the first signal has not been received, the procedure returns directly to step S26 described above.

In order to prevent an unauthorized user from using the portable device 1, and prevent crucial data from been accessed by a person with malicious intent, the password verification procedure must be used. In step S32, the analyzing sub-module 104 analyzes whether to use the password verification procedure. If the password verification procedure is undesired used, the procedure returns directly to step S30 described above. Otherwise, if the password verification procedure is desired used, in step S34, the processing sub-module 106 locks the hot key and the mouse of the portable device 1, and the input sub-module 100 provides a user interface for inputting the response password by the user.

In step S36, the analyzing sub-module 104 analyzes whether the inputted response password is valid by comparing the response password with the verifying password. If the inputted response password is valid, in step S38, the processing sub-module 106 turns off the alarm unit 16, and unlocks the locked hot key and the locked mouse of the portable device 1. Otherwise, if the inputted response password is invalid, in step S40, the alarm unit 16 keeps on sounding the alarm, and locking the hot key and the mouse of the portable device 1. The output sub-module 102 displays basic information of the owner of the portable device 1 by using a display of the portable device 1.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A burglar alarm system for a portable device configured with a vibrating sensor, the vibrating sensor structured and arranged for generating a first voltage upon sensing a vibration coming from the portable device, and sending a first signal if the first voltage exceeds a predefined voltage, the system comprising:
an alarm unit structured and arranged for sending an alarm when receiving an alarm signal; and
a security module structured and arranged for determining whether to generate and output the alarm signal to the alarm unit, the security module comprising:
an input sub-module structured and arranged for setting security parameters that comprise the predefined voltage and a verifying password, receiving the first signal sent from the vibrating sensor, and providing a user interface for inputting a response password by a user;
an analyzing sub-module structured and arranged for analyzing whether the first signal has been received by way of communicating with the input sub-module, and analyzing whether the response password is valid by comparing the response password with the verifying password; and
a processing sub-module structured and arranged for generating the alarm signal to the alarm unit for sending an alarm and locking a hot key of the portable device if the first signal has been received, and for turning off the alarm unit and unlocking the locked hot key if the response password is valid.

2. The system as claimed in claim 1, wherein the security module is installed in the portable device.

3. The system as claimed in claim 1, wherein the alarm sent the alarm unit is used for informing the portable device owner that the portable device is in a danger state of being stolen.

4. The system as claimed in claim 1, wherein the alarm unit is selected from the group consisting of a sound device for sending the alarm with voice/sound and a light alarm device for sending the alarm with lights.

5. The system as claimed in claim 1, wherein the security parameters further comprise the hot key.

6. The system as claimed in claim 5, wherein the hot key is set for enabling/disabling the security module.

7. The system as claimed in claim 1, wherein the security module further comprises: an output sub-module for displaying basic information of the portable device owner.

8. A burglar alarm method for a portable device configured with a vibrating sensor, the vibrating sensor structured and arranged for generating a first voltage upon sensing a vibration coming from the portable device, and sending a first signal if the first voltage exceeds a predefined voltage, the method comprising the steps of:
setting security parameters that comprise the predefined voltage and a verifying password;
receiving the first signal sent from the vibrating sensor if a hot key of the portable device is pressed;
generating an alarm signal to an alarm unit for sending an alarm and locking the hot key if the first signal has been received;
providing a user interface for inputting a response password by a user; analyzing whether the response password is valid by comparing the response password with the verifying password;
turning off the alarm unit and unlocking the locked hot key if the response password is valid; and sending the alarm via the alarm unit and locking the hot key if the response password is invalid.

9. The method as claimed in claim 8, wherein the alarm is used for informing the portable device owner that the portable device is in a danger state of being stolen.

10. The method as claimed in claim 8, wherein the security parameters further comprise the hot key.

11. The system as claimed in claim 10, wherein the hot key is set for enabling/disabling the security module.

12. The method as claimed in claim 8, further comprising the step of: displaying basic information of the portable device owner.
